(19) United States
(12) Patent Application Publication
(10) Pub. No.: US 2020/0012359 A1
(43) Pub. Date: Jan. 9, 2020

(54) STYLUS BUTTON CONTROL

(71) Applicant: FlatFrog Laboratories AB, Lund (SE)

(72) Inventors: Kristofer JAKOBSON, Malmo (SE); Nicklas OHLSSON, Bunkeflostrand (SE); Pablo JAVIER CASES MÖLLER, Lomma (SE)

(21) Appl. No.: 16/483,322

(22) PCT Filed: Jan. 31, 2018
(86) PCT No.: PCT/SE2018/050070

§ 371 Date: Aug. 2, 2019

(30) Foreign Application Priority Data
Feb. 7, 2017 (SE) 1730034-4

(51) Int. Cl. G06F 3/0354; G06F 3/038; G06F 3/0488

(52) U.S. Cl. CPC G06F 3/03545; G06F 3/0488; G06F 3/0383

(57) ABSTRACT

A stylus is described for controlling a computer device. The stylus comprises at least one user control and a contact sensor configured to detect a contact between the controller device and a touch surface. The stylus is configured to: detect an activation of the user control; whilst the user control continues to be activated, detecting, using the contact sensor, whether a contact between the controller device and a touch surface has occurred and transmitting a first control signal when a contact is detected, where no contact is detected, transmitting a second control signal when the user control is deactivated.

### TECHNICAL FIELD

The present invention generally relates to improved stylus suitable for touch surfaces and configured for providing dynamic controls.

### BACKGROUND ART

To an increasing extent, touch-sensitive panels are being used for providing input data to computers, electronic measurement and test equipment, gaming devices, etc. The panel may be provided with a graphical user interface (GUI) for a user to interact with using e.g. a pointer, stylus or one or more fingers. The GUI may be fixed or dynamic. A fixed GUI may e.g. be in the form of printed matter placed over, under or inside the panel. A dynamic GUI can be provided by a display screen integrated with, or placed underneath, the panel or by an image being projected onto the panel by a projector.

For most touch systems, a user may place a finger onto the surface of a touch panel in order to register a touch. Alternatively, a stylus may be used. A stylus is typically a pen shaped object with one end configured to be pressed against the surface of the touch panel. An example of a stylus according to the prior art is shown in FIG. 1. Use of a stylus 100 may provide improved selection accuracy and pointer precision over a simple finger touch. This can be due to the engineered stylus tip 20 providing a smaller and/or more regular contact surface with the touch panel than is possible with a human finger. Also, muscular control of an entire hand in a pen holding position can be more precise than a single finger for the purposes of pointer control due to lifelong training in the use of pens and pencils.

Two types of stylus exist for touch systems. An active stylus is a stylus typically comprising some form of power source and electronics to transmit a signal to the host touch system. The type of signal transmitted can vary but may include position information, pressure information, tilt information, stylus ID, stylus type, ink colour etc. The source of power for an active stylus may include a battery, capacitor, or an electrical field for providing power via inductive coupling. Without power, an active stylus may lose some or all of its functionality.

An active stylus may be readily identified by a host system by receiving an electronic stylus ID from the active stylus and associating the stylus ID with position information relating to the contact position between the stylus and the touch surface of the host system.

However, styluses do not lend themselves to enhanced control functionality featuring a large number of controls, such as buttons, due to the limited surface of a stylus on which to place the controls. Therefore, what is needed is a way of improving the control functionality of a stylus using a limited number of controls.

### SUMMARY

It is an objective of the invention to at least partly overcome one or more of the above-identified limitations of the prior art.

One or more of these objectives, as well as further objectives that may appear from the description below, are at least partly achieved by means of a method for data processing, a computer readable medium, devices for data processing, and a touch-sensing apparatus according to the independent claims, embodiments thereof being defined by the dependent claims.

### BRIEF DESCRIPTION OF DRAWINGS

Embodiments of the invention will now be described in more detail with reference to the accompanying schematic drawings.

FIG. 1a is a view of a stylus featuring two control buttons.

FIG. 1b is an internal view of a stylus featuring a power source, control circuitry, and radio features.

FIGS. 2a-2d shows a sequence of stylus actions as applied by a user.

### DETAILED DESCRIPTION OF EMBODIMENTS

The present invention relates to styluses and touch panels and the use of techniques for providing control of a computer device using a stylus and touch panel. Throughout the description the same reference numerals are used to identify corresponding elements.

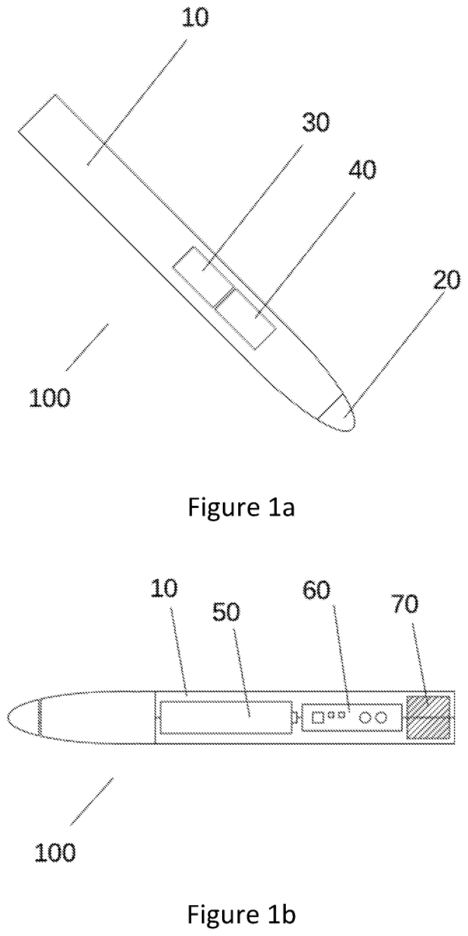

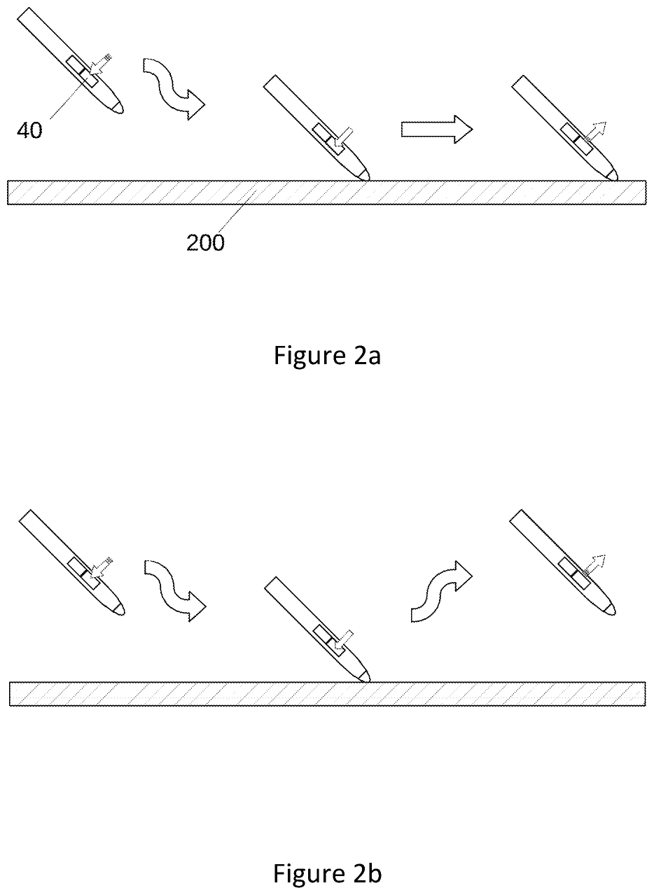

FIG. 1a illustrates the external components of an example of a stylus according to an embodiment of the present invention. Tip 20 forms the component which will come into contact with a touch sensitive surface. The main body of the stylus is formed by casing 10. External buttons 30 and 40 are located on casing 10 and may be pressed individually or form a rocker switch, ensuring only one switch may be pressed at a time.

FIG. 1b illustrates the internal components of an example of a stylus according to an embodiment of the present invention. Tip 20 may be electrically connected to control system 60. Control system 60 is provided with power from battery 50 and is electrically connected to antenna coil 70 for transmitting data to a receiver in a computer device (not shown) having a touch surface 200.

In a preferred embodiment, tip 20 is configured to detect contact with a touch surface and generate a corresponding signal. Tip 20 comprises a contact sensor that may comprise a pressure detector, projected capacitance sensor, or other sensor suitable for detecting the application of the stylus tip to a surface. In this embodiment, when the stylus of this embodiment is applied to a touch sensitive surface, the tip 20 detects the contact with a surface and signals control system 60. Similarly, the depression of either of the buttons 30 or 40 is signalled to control system 60. Control system 60 is configured to generate and transmit a signal via antenna coil 70 to a receiver in a touch sensing system, wherein the signal is generated in dependence on at least the signal from tip 20, button 30, and/or button 40.

In one embodiment, computer device (not shown) may comprise a touch sensitive surface, such as a touch pad or touch display as is well known in the art. The computer device may be connected to a display configured to display UI components controlled by input to the touch sensitive surface. In one embodiment, the touch sensitive surface and display are connected to form a touch sensitive display configured to receive and display a corresponding user interface control for a finger or stylus touch. Examples of a user interface control may include a paint brush or pen tip for applying digital ink to a digital canvas, an eraser for removing digital ink from a digital canvas, a select tool for selecting portions of a digital canvas, etc.

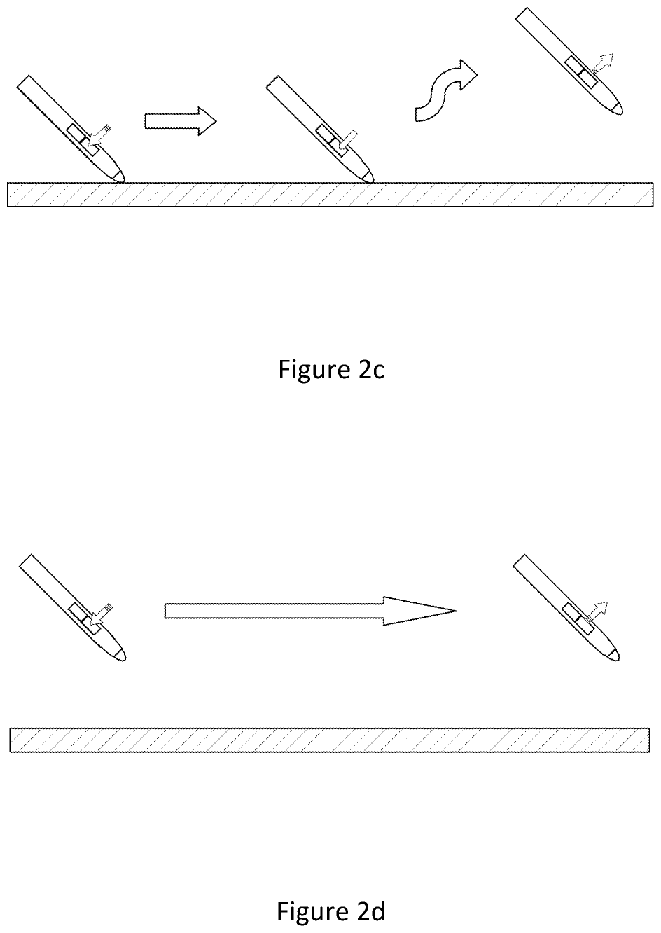

FIG. 2a shows a sequence of usage of the stylus by a user. The figure shows a time sequence of actions by starting with the left-most position and finishing with the right-most position. In this figure, the user presses button 40 whilst holding the stylus away from touch surface 200. Whilst holding button 40, the user applies the stylus to touch surface 200. Finally, the user releases button 40, whilst continuing to apply the stylus to touch surface 200.

In a preferred embodiment of the sequence shown in FIG. 2a, the stylus 100 is configured to detect the press of button 40. The stylus then waits until either a contact is detected at tip 20, or button 40 is released. In FIG. 2a, a contact is detected at tip 20 whilst the button 40 is still pressed and a first control signal is transmitted to the computer device. In response to receiving the first control signal, the computer device is configured to apply a first function to a user interface control matched to the stylus. In one embodiment, the first function is to erase ink and/or text at a location specified by the user interface control. Alternatively, the first function is to select an area specified by the user interface control for further manipulation.

In one embodiment, the release of button 40 whilst tip 20 is still applied to the touch surface results in no change to the control signal. In an alternative embodiment, a third control signal is transmitted from the stylus to the computer device when button 40 is released whilst tip 20 is still applied to the touch surface. In response to receiving the second control signal, the computer device is configured to apply a second function to the user interface control matched to the stylus from the point at which the third control signal is received. In one embodiment, the second function is to select an area specified by the user interface control matched to the stylus for further manipulation.

FIG. 2b shows another sequence of usage of the stylus by a user. The user presses button 40 whilst holding the stylus away from touch surface 200. Whilst holding button 40, the user applies the stylus to touch surface 200. Finally, the user lifts the stylus away from touch surface 200 and releases button 40.

In a preferred embodiment, the stylus is configured to generate a control signal corresponding to that described in the preferred embodiment of FIG. 2a. A contact is detected at tip 20 whilst the button 40 is still pressed and a first control signal is transmitted to the computer device. In response to receiving the first control signal, the computer device is configured to apply a first function to the user interface control matched to the stylus. Preferably, the computer device is configured to cease applying the first function once the stylus is removed from touch surface 200.

FIG. 2c shows another sequence of usage of the stylus by a user. The user presses button 40 whilst applying the stylus to touch surface 200. Whilst holding button 40, the user continues to apply the stylus to touch surface 200. Finally, the user lifts the stylus away from touch surface 200 and releases button 40.

In a preferred embodiment of the sequence shown in FIG. 2c, button 40 is pressed whilst the stylus 100 is applied to touch surface 200. Once the press of button 40 is detected, a first control signal is transmitted to the computer device. In response to receiving the first control signal, the computer device is configured to apply a first function to the user interface control matched to the stylus from the point at which the first control signal. Preferably, the computer device is configured to cease applying the first function once the stylus is removed from touch surface 200.

FIG. 2d shows another sequence of usage of the stylus by a user. The user presses button 40 whilst holding the stylus away from touch surface 200. Without applying stylus to the touch surface at any intervening time, the user releases button 40.

In a preferred embodiment of the sequence shown in FIG. 2d, the stylus 100 is configured to detect the press of button 40 whilst the stylus is not applied to the touch surface. The stylus then waits until either a contact is detected at tip 20, or button 40 is released. In FIG. 2d, no contact is detected at tip 20 whilst the button 40 is still pressed. Eventually button 40 is released. Stylus 100 is configured to determine that no contact with a touch surface occurred during the period between the activation of button 40 and the de-activation of button 40 and consequently transmits a second control signal to the computer device. In response to receiving the third control signal, the computer device is configured to carry out a first action. In one embodiment, the first action is to simulate a keypress. In one embodiment, the first action is to move to the next page of a document displayed by the computer device.

In a preferred embodiment in which stylus 100 has two buttons, button 40 and button 30, stylus 100 is configured to transmit a fourth, fifth or sixth control signal in response to a usage sequence of button 30 corresponding to the embodiments described above in relation to FIGS. 2a-2d, wherein the fourth, fifth or sixth control signals correspond to the first, second, and third control signals respectively.

In an embodiment comprising button 40 and button 30, the computer device is configured to carry out a second action in response to receiving a sixth control signal. In one embodiment, the second action is to simulate a keypress. In one embodiment, the second action is to move to the previous page of a document displayed by the computer device.

In an alternative embodiment, the stylus simply transmits the status of the contact sensor, button 30, and button 40 to the computer device. The logic needed to generate the same behaviour at the user interface control level as described above is instead handled by the computer device. In this embodiment, the computer device is configured to determine an activation of the user control from a user control signal generated by the user control and transmitted from the controller device to the computer device. Similarly, the computer device is configured to determine whether a contact between the controller device and a touch surface has occurred in dependence on a contact sensor signal generated by the contact sensor and transmitted from the controller device to the computer device. The computer device is then configured to perform at least one of the following:

1) Apply a default function to the user interface control in response to detecting contact between the controller device and a touch surface with no corresponding activation of the user control.

2) Apply a first function to the user interface control in response to detecting an activation of the user control and subsequent contact between the controller device and a touch surface before de-activation of the user control is detected.
3) Executing a first action where activation and subsequent de-activation of the user control is detected, without an intermediate contact between the controller device and a touch surface.
4) Apply a second function to the user interface control in response to detecting de-activation of the user control whilst contact between the controller device and a touch surface is detected.

In one embodiment, several user interface elements on a digital canvas may be grouped together via the following gesture: Whilst holding down a button of the stylus, applying the stylus to the touch surface at the location of each of the user interface elements in order to select each one by one. Preferably, the stylus is lifted away from the touch surface in-between application to the user interface elements. In one example, the user interface elements are post-it notes and the above process allows the selection of multiple post-it notes. When the stylus is applied to the touch surface and the button is released, the selected user interface elements are aligned in a geometric arrangement around the location of the stylus. The geometric arrangement may include a grid arrangement of the user interface elements around the stylus location. In one embodiment, the user interface elements are arranged at a default position if the user releases the button whilst the stylus is not applied to the touch surface.

The above gesture may also be connected to a specific electronic stylus ID. In this embodiment, selection of user interface elements is done according to the electronic stylus ID of the stylus selecting the user interface elements. When the stylus having the specific electronic stylus ID is applied to the touch surface and the button is released, the user interface elements selected using the specific electronic stylus ID are aligned in a grid geometric arrangement around the location of the stylus. This feature allows two or more users to do selection and grouping of different user interface elements according to the above gesture simultaneously.

1.-12. (canceled)

13. A method of controlling a computer device using a controller device configured to be applied to a touch surface, the controller device comprising at least one user control, a contact sensor configured to detect a contact between the controller device and a touch surface, and a transmitter to transmit a signal to the computer device, the method comprising:
detecting an activation of the user control;
whilst the user control continues to be activated, detecting whether a contact between the controller device and a touch surface has occurred and triggering a first event when a contact is detected, and
where no contact is detected, triggering a second event when the user control is deactivated.

14. The method of claim 13, wherein the controller device is a stylus and the user control is a button, proximity sensor, or pressure sensor.

15. The method of claim 13, wherein the contact sensor is a pressure sensor, proximity sensor, or projected capacitance sensor.

16. The method of claim 13, wherein the computer device is configured to determine co-ordinates of contact applied to the touch surface and display a corresponding user interface control on a display, and
wherein the step of detecting an activation of the user control and the step of detecting whether a contact between the controller device and a touch surface has occurred are performed by the computer device in dependence on respectively a user control signal generated by the user control and contact sensor signal generated by the contact sensor and transmitted from the control device and to the computer device and
wherein the step of triggering a first and second event comprises applying a first function to the user interface control and executing a first action respectively.

17. The method of claim 13, wherein triggering a first event comprises the transmitting a first control signal from the controller device to the computer device and wherein triggering a second event comprises transmitting a second control signal from the controller device to the computer device.

18. The method of claim 17, wherein the computer device is configured to determine co-ordinates of contact applied to the touch surface and display a corresponding user interface control on a display, the method further comprising:
the computer device applying a first function to the user interface control in response to receiving the first control signal, and
the computer device executing a first action in response to receiving the second control signal.

19. The method of claim 16, wherein applying a first function to the user interface control comprises erasing ink and/or text at the location of the first control signal.

20. The method of claim 16, wherein executing a first action comprises simulating a page-down keypress.

21. The method of claim 13, the method further comprising:
whilst a contact between the controller device and a touch surface is maintained, triggering a third event when the user control is deactivated.

22. The method of claim 13, wherein the controller device further comprising a second user control, the method comprising:
detecting an activation of the second user control;
whilst the second user control continues to be activated, detecting, using the contact sensor, whether a contact between the controller device and a touch surface has occurred and triggering a fourth event when a contact is detected,
where no contact is detected, triggering a fifth event signal when the second user control is deactivated.

23. The method of claim 22, the method further comprising:
whilst a contact between the controller device and a touch surface is maintained, triggering a sixth event when the second user control is deactivated.

24. A controller device for controlling a computer device and configured to be applied to a touch surface, the controller device comprising at least one user control and a contact sensor configured to detect a contact between the controller device and a touch surface, the controller device configured to:
detect an activation of the user control;
whilst the user control continues to be activated, detecting, using the contact sensor, whether a contact between the controller device and a touch surface has occurred and transmitting a first control signal when a contact is detected, and
where no contact is detected, transmitting a second control signal when the user control is deactivated
